(19) United States
(12) Patent Application Publication
(10) Pub. No.: US 2005/0045754 A1
(43) Pub. Date: Mar. 3, 2005

(54) Methods of processing kaolin from high grit content crude clay ore

(76) Inventor: David M. Avant JR., Sandersville, GA (US)

Correspondence Address: MYERS BIGEL SIBLEY & SAJOVEC, PO BOX 37428, RALEIGH, NC, 27627, US

(21) Appl. No.: 10/648,706

(22) Filed: Aug. 26, 2003

(51) Int. Cl. B02C 19/12

(52) U.S. Cl. 241/23

(57) ABSTRACT

A method of processing crude clay ore having a high grit content includes drying crude clay ore to remove moisture entrained therein, pulverizing the crude clay ore into individual mineral particles, and separating the individual mineral particles into respective product streams. Drying and pulverizing are performed substantially simultaneously by injecting crude clay ore into a heated air stream flowing through a dryer that has a plurality of rotating paddles and baffles therein. The air stream forces the crude clay ore through the plurality of rotating paddles and baffles to pulverize the crude clay ore into individual mineral particles. The individual mineral particles leaving the dryer are then separated into respective product streams by particle size via one or more conventional classification techniques.

### FIELD OF THE INVENTION

The present invention relates generally to kaolin, and more particularly to methods of processing kaolin from crude clay ore.

### BACKGROUND OF THE INVENTION

The term “kaolin” as it is used herein relates to near-white clay deposits which are dominantly comprised of the mineral kaolinite having the formula Al₄Si₄O₁₀(OH)₈ possibly with lesser amounts of the kaolin-group mineral, halloysite. Geologically, kaolins appear in the form of deposits of relatively fine particle size, resulting from the weathering of feldspathic rocks. Kaolin deposits can be classified as primary and secondary. Primary kaolins originate from the weathering of rocks such as granite or granite gneiss which contain high concentrations of feldspathic minerals and are found in the location where they were formed. Secondary kaolins originate from being borne along by river or lake freshwater currents, with subsequent settling and deposition in association with other minerals such as quartz and mica.

Kaolin is used widely as a pigment, filler, coater, extender, ceramic raw material, catalyst base, electrical insulator, and pharmaceutical. Some more prominent uses include paper filling and coating; paint, plastic, adhesive, and ink pigment; rubber reinforcing agent; ceramic raw material from porcelain, dinnerware, tile, and enamels; catalyst base for petroleum cracking and auto exhaust emission catalytic control devices; cosmetics base; and digestive coating remedy.

Crude kaolin, however, typically contains various impurities, most which are removed in order to make a commercially useful product, particularly as a paper coating. The coarser impurities, generally quartz, muscovite, and heavy minerals, are typically separated by settling or screening. The partial or complete removal of these impurities in a economical manner has been the subject of much research and process equipment development in the industry.

Conventionally, impurities having a particle size greater than about three-hundred-twenty-five (325) mesh (44 microns) is designated as grit. Two conventional processes utilized to remove grit from crude ore are “wet” processing and “dry” processing. In wet processing, the crude ore is slurried to about forty percent (40%) solids in a mixer, often referred to as a “blunger.” The slurry is then either pumped through hydrocyclones or settled in classification drag boxes and screened to remove grit. The degritted slurry is then further refined to make products for the paper coating industry. In dry processing, crude ore is mined, dried, ground in mills, and air classified to remove grit.

Unfortunately, the production of refined kaolin from high grit content crude clay ore via conventional wet and dry processes often produces a large amount of reject or waste material. In addition to the transportation costs associated with hauling crude clay ore from the mine, moving and disposal of this waste material further adds to the cost of kaolin production. The kaolin industry generally regards crude clay ore having more than ten percent (10%) grit uneconomical for wet processing due to high losses during degritting. The kaolin industry generally regards crude clay ore having more than five percent (5%) grit uneconomical for dry processing due to high losses during degritting.

Because of the increased costs associated with processing crude clay ore having high grit content, the kaolin industry prefers to mine ore from deposits having very low grit content (i.e., less than 10% for wet processing and less than 5% for dry processing). As a result, there are vast reserves of kaolin bearing ore not being mined for kaolin production because they contain too much grit to be processed economically via conventional kaolin production processes.

### SUMMARY OF THE INVENTION

In view of the above discussion, a method of processing crude clay ore having a high grit content (i.e., greater than 5%), according to embodiments of the present invention includes drying mined crude clay ore to remove moisture entrained therein, pulverizing the crude clay ore into individual mineral particles, and separating the individual mineral particles into respective product streams (e.g., sand, mica and kaolin product streams). Drying and pulverizing are performed substantially simultaneously by injecting the crude clay ore into a heated air stream flowing through a dryer that has a plurality of rotating paddles and baffles therein. The air stream forces the crude clay ore through the plurality of rotating paddles and baffles to pulverize the crude clay ore into individual mineral particles. The pulverized mineral particles become entrained in the air stream and are removed from the dryer via the air stream for subsequent separation.

The individual mineral particles leaving the dryer are then separated into respective product streams by particle size via one or more conventional classification techniques. For example, sand particles are separated from the pulverized crude clay ore leaving the dryer via an air cyclone, and mica and kaolin particles are separated into respective product streams via an air classifier. In addition to producing refined kaolin, embodiments of the present invention produce sand and mica product streams that can be utilized for the production of various sand and mica products via known processes.

According to embodiments of the present invention, crude clay ore having extremely high grit content (e.g., between about five percent and seventy five percent (5%-75%) grit) can be processed. Because the present invention, can efficiently separate the various minerals from crude clay ore for subsequent use, crude clay ore that previously was deemed unusable for kaolin production can now be processed efficiently and economically. Moreover, the present invention now allows crude clay ore from virtually any ore deposit to be utilized in the production of kaolin.

### BRIEF DESCRIPTION OF THE DRAWINGS

The accompanying drawing, which forms a part of the specification, illustrates key embodiments of the present invention. The drawing and description together serve to fully explain the invention.

FIGS. 1-2 are flowcharts that illustrate methods of processing crude clay ore having a high grit content, according to embodiments of the present invention.

### DETAILED DESCRIPTION OF THE INVENTION

The present invention now is described more fully hereinafter with reference to the accompanying drawing, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

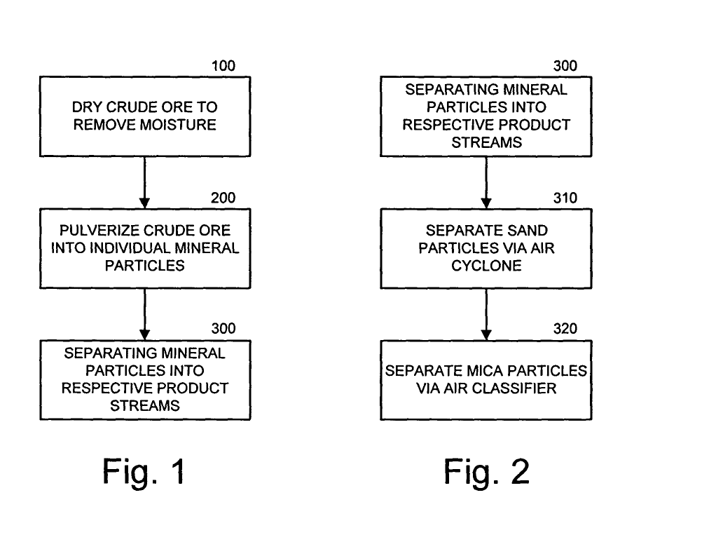

Referring now to FIG. 1, a method of processing crude clay ore having a high grit content includes drying crude clay ore to remove moisture entrained therein (Block 100), pulverizing the crude clay ore into individual mineral particles (Block 200), and separating the individual mineral particles into respective product streams (Block 300). Typically, mined crude clay ore has a moisture content of up to about twenty percent (20%).

Drying (Block 100) and pulverizing (Block 200) are performed substantially simultaneously by injecting crude clay ore into a heated air stream flowing through a dryer that has a plurality of rotating paddles and baffles therein. An exemplary dryer is an AST (air swept tubular) dryer available from Scott Equipment Company, New Prague, Minn., and which is described in U.S. Pat. No. 5,570,517, the disclosure of which is incorporated herein by reference in its entirety.

The air stream forces the crude clay ore through the plurality of rotating paddles and baffles to pulverize the crude clay ore into individual mineral particles. The rotating paddles and baffles beats and flops the airborne crude clay ore around within the dryer such that, as the crude clay ore dries, it becomes pulverized. The pulverized mineral particles, once they are sufficiently dry and sufficiently small, become entrained in the air stream and are removed from the dryer via the air stream for subsequent separation (Block 300). According to embodiments of the present invention, the heated air stream has a temperature of between about 600° F. and about 1,000° F., and has a flow rate of between about five thousand cubic feet per minute and about fifty thousand cubic feet per minute (5,000-50,000 cfm).

The individual mineral particles leaving the dryer are then separated into respective product streams (e.g., sand, mica and kaolin product streams) (Block 300) by particle size via one or more conventional classification techniques. For example, sand particles are separated from the pulverized crude clay ore leaving the dryer via an air cyclone (Block 310, FIG. 2), and mica and kaolin particles are separated into respective product streams via an air classifier (Block 320, FIG. 2). According to embodiments of the present invention, sand particles having a size greater than about one hundred (100) mesh can be removed via an air cyclone.

Mica particles (as well as other non-kaolin particles) having a size greater than about three hundred twenty five (325) mesh can be removed via an air classifier.

An exemplary air cyclone that can be used to separate sand from the pulverized crude clay ore leaving the dryer is an RSG-PE Model cyclone, available from RSG, Inc., Sylacauga, Ala. Cyclones for separating sand from pulverized crude clay ore according to embodiments of the present invention may have various sizes and throughput capacities, without limitation.

An exemplary air classifier that can be used to separate mica particles and other non-kaolin particles from the pulverized crude clay ore leaving the dryer is an RSG-ACS or MCS Model classifier, available from RSG, Inc., Sylacauga, Ala. Classifiers for separating sand from pulverized crude clay ore according to embodiments of the present invention may have various sizes and throughput capacities, without limitation.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A method of processing crude clay ore having a high grit content, comprising:
removing moisture entrained in crude clay ore;
pulverizing the crude clay ore into individual mineral particles substantially simultaneously with the drying step; and
separating the individual mineral particles into respective product streams.

2. The method of claim 1, wherein removing moisture and pulverizing the crude clay ore is performed by injecting the crude clay ore into a heated air stream flowing through a dryer, wherein the dryer comprises a plurality of rotating paddles, and wherein the air stream forces the crude clay ore through the plurality of rotating paddles to pulverize the crude clay ore into individual mineral particles.

3. The method of claim 2, wherein the heated air stream has a temperature of between about 600° F. and about 1,000° F.

4. The method of claim 2, wherein the heated air stream has a flow rate of between about five thousand cubic feet per minute and about fifty thousand cubic feet per minute (5,000-50,000 cfm).

5. The method of claim 1, wherein separating the individual mineral particles into respective product streams comprises separating the individual mineral particles into sand, mica and kaolin product streams.

6. The method of claim 1, wherein separating the individual mineral particles into respective product streams comprises separating the individual mineral particles by particle size.

7. The method of claim 1, wherein separating the individual mineral particles into respective product streams comprises:
separating sand particles into a respective product stream via an air cyclone; and
separating mica and kaolin particles into respective product streams via an air classifier.

8. The method of claim 7, wherein separating sand particles via an air cyclone comprises separating sand particles having a size greater than about one hundred (100) mesh.

9. The method of claim 7, wherein separating mica particles into a respective product stream comprises separating mica particles having a size greater than about three hundred twenty five (325) mesh.

10. A method of processing crude clay ore having a high grit content, comprising:
injecting crude clay ore having a grit content of between about five percent and seventy five percent (5%-75%) into a heated air stream flowing through a dryer, wherein the dryer comprises a plurality of rotating paddles, and wherein the air stream forces the crude clay ore through the plurality of rotating paddles to pulverize the crude clay ore into individual mineral particles; and
separating the individual mineral particles into sand, mica and kaolin product streams.

11. The method of claim 10, wherein the heated air stream has a temperature of between about 600° F. and about 1,000° F.

12. The method of claim 10, wherein the heated air stream has a flow rate of between about five thousand cubic feet per minute and about fifty thousand cubic feet per minute (5,000-50,000 cfm).

13. The method of claim 10, wherein separating the individual mineral particles into respective product streams comprises separating the individual mineral particles by particle size.

14. The method of claim 10, wherein separating the individual mineral particles into respective product streams comprises:
separating sand particles into a respective product stream via an air cyclone; and
separating mica and kaolin particles into respective product streams via an air classifier.

15. The method of claim 14, wherein separating sand particles via an air cyclone comprises separating sand particles having a size greater than about one hundred (100) mesh.

16. The method of claim 14, wherein separating mica particles into a respective product stream comprises separating mica particles having a size greater than about three hundred twenty five (325) mesh.

17. A method of processing crude clay ore having a high grit content, comprising:
injecting crude clay ore having a grit content of between about five percent and seventy five percent (5%-75%) into a heated air stream flowing through a dryer, wherein the dryer comprises a plurality of rotating paddles, and wherein the air stream forces the crude clay ore through the plurality of rotating paddles to pulverize the crude clay ore into individual mineral particles, wherein the heated air stream has a temperature of between about 600° F. and about 1,000° F., and wherein the heated air stream has a flow rate of between about five thousand cubic feet per minute and about fifty thousand cubic feet per minute (5,000-50,000 cfm); and
separating the individual mineral particles into sand, mica and kaolin product streams.

18. The method of claim 17, wherein separating the individual mineral particles into respective product streams comprises separating the individual mineral particles by particle size.

19. The method of claim 17, wherein separating the individual mineral particles into respective product streams comprises:
separating sand particles into a respective product stream via an air cyclone; and
separating mica and kaolin particles into respective product streams via an air classifier.

20. The method of claim 19, wherein separating sand particles via an air cyclone comprises separating sand particles having a size greater than about one hundred (100) mesh.

21. The method of claim 19, wherein separating mica particles into a respective product stream comprises separating mica particles having a size greater than about three hundred twenty five (325) mesh.
